(19) United States
(12) Patent Application Publication
(10) Pub. No.: US 2025/0138865 A1
(43) Pub. Date: May 1, 2025

(54) PRIORITY-DRIVEN MIGRATION OPTIMIZATION SYSTEM

(71) Applicant: Dell Products L.P., Round Rock, TX (US)

(72) Inventors: Abhishek Mishra, Bangalore (IN); Apoorva Neyyanira Ravi, Bangalore (IN); Kumar Saurav, Bangalore (IN)

(73) Assignee: Dell Products L.P., Round Rock, TX (US)

(21) Appl. No.: 18/384,931

(22) Filed: Oct. 30, 2023

(51) Int. Cl. G06F 9/46

(52) U.S. Cl. CPC G06F 9/465

(57) ABSTRACT

Methods, system, and non-transitory processor-readable storage medium for a component development migration system are provided herein. An example method includes a reverse proxy server that receives a Hypertext Transfer Protocol (HTTP) request from a client system. The reverse proxy server intercepts the HTTP request between the client system and a server. A listener module receives a digital footprint of the HTTP request, where the digital footprint identifies a feature associated with an enterprise application. The method determines a feature score associated with the feature, and an overall feature score using a weighted feature score and a weighted feature priority score. The method then migrates development of a component of the enterprise application to a second enterprise application according to the overall feature score.

### FIELD

The field relates generally to migrating software, and more particularly to migrating components of enterprise applications in information processing systems.

### BACKGROUND

Migrating an application to a new platform is a challenging task. Typically, a roadmap is created to determine how the development of the components of the application is migrated to the new platform. A backlog can occur when less relevant components of the application are migrated prior to the more relevant components of the application.

### SUMMARY

Illustrative embodiments provide techniques for implementing a component development migration system in a storage system. For example, illustrative embodiments provide a component development migration system that receives, by a reverse proxy server, a Hypertext Transfer Protocol (HTTP) request from a client system, where the reverse proxy server intercepts the HTTP request between the client system and a server. A listener module associated with the reverse proxy server captures a digital footprint of the HTTP request, where the digital footprint identifies a feature associated with an enterprise application. The component development migration system determines a feature score associated with the feature, and determines an overall feature score using a weighted feature score and a weighted feature priority score. The component development migration system migrates development of a component of the enterprise application to a second enterprise application according to the overall feature score, where the feature is associated with the component. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a component development migration system in an illustrative embodiment.

FIG. 2 shows a component development migration system in an illustrative embodiment.

FIG. 3 shows a reverse proxy server interfacing with client systems and a server in an illustrative embodiment.

FIG. 4 shows a flow diagram of a process for a component development migration system in an illustrative embodiment.

FIG. 5 illustrates an example node data structure in an illustrative embodiment.

FIGS. 6A and 6B respectively illustrate a node data structure with a success HTTP response and a node structure with an unsuccessful HTTP response in an illustrative embodiment.

FIG. 7 illustrates example graph data structures in an illustrative embodiment.

FIG. 8 illustrates a normalized graph data structure where the node data structures are ranked according to priority in an illustrative embodiment.

FIGS. 9 and 10 show examples of processing platforms that may be utilized to implement at least a portion of a component development migration system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a component development migration system, which technique may be used to provide, among other things, migration of the development of components of an enterprise application. The component development migration system receives, by a reverse proxy server, a Hypertext Transfer Protocol (HTTP) request from a client system, where the reverse proxy server intercepts the HTTP request between the client system and a server. A listener module associated with the reverse proxy server captures a digital footprint of the HTTP request, where the digital footprint identifies a feature associated with an enterprise application. The component development migration system determines a feature score associated with the feature, and determines an overall feature score using a weighted feature score and a weighted feature priority score. The component development migration system migrates development of a component of the enterprise application to a second enterprise application according to the overall feature score, where the feature is associated with the component. Other types of processing devices can be used in other embodiments.

Conventional technologies utilize feedback from a select user group to determine the migration of components from an enterprise application to a second enterprise application, leading to ineffective decision making and delays in the migration process, and resulting in suboptimal outcomes. Conventional technologies fail to focus on the user journeys as the driver in the migration process. Conventional technologies fail to generate a more efficient, data driven roadmap by using digital footprints provided by user journeys. Conventional technologies fail to use a user journey driven approach that extracts user journey data, creates a prioritized feature roadmap, and facilitates effective decision making during the migration process. Conventional technologies fail to prioritize migration of features of components based on hits from users as they interact with those components. Conventional technologies fail to rank migration of those features according to business priorities. Conventional technologies fail to merge both the user journey data and business priorities to provide a migration priority that accurately reflects the overall business needs.

By contrast, in at least some implementations in accordance with the current technique as described herein, a component development migration system receives, by a reverse proxy server, a Hypertext Transfer Protocol (HTTP) request from a client system, where the reverse proxy server intercepts the HTTP request between the client system and a server. A listener module associated with the reverse proxy server captures a digital footprint of the HTTP request, where the digital footprint identifies a feature associated with an enterprise application. The component development migration system determines a feature score associated with the feature, and determines an overall feature score using a weighted feature score and a weighted feature priority score. The component development migration system migrates development of a component of the enterprise application to a second enterprise application according to the overall feature score, where the feature is associated with the component.

Thus, a goal of the current technique is to provide a method and a system for component development migration that focuses on the user journeys as the driver in the migration process. Another goal is to prioritize critical functionalities based on the user needs and behavior. By prioritizing critical functionalities based on the user needs and behavior, the migration process is carried out in a more targeted and efficient manner. Another goal is to combine the feature priorities and the user journey data to create a measure of complexity that reflects both the business value and user experience of a migrated feature. Another goal is to generate a more efficient, data driven roadmap by using digital footprints provided by user journeys. Another goal is to use a user journey driven approach that extracts user journey data, creates a prioritized feature roadmap, and facilitates effective decision making during the migration process. Another goal is to prioritize migration of features of components based on hits from users as they interact with those components. Another goal is to rank migration of those features according to business priorities. Another goal is to merge both the user journey data and business priorities to provide a migration priority that accurately reflects the overall business needs. Another goal is to ensure that the development team focuses on migrating the most important and impactful features first. Another goal is to provide a more data-driven and strategic approach to feature development, resulting in a better user experience and increased business value. Yet another goal is to enable more efficient use of development resources by ensuring that the team is working on the highest priority features first.

In at least some implementations in accordance with the current technique described herein, the use of a component development migration system can provide one or more of the following advantages: focusing on the user journeys as the driver in the migration process, prioritizing critical functionalities based on the user needs and behavior, combining the feature priorities and the user journey data to create a measure of complexity that reflects both the business value and user experience of a migrated feature, generating a more efficient, data driven roadmap by using digital footprints provided by user journeys, using a user journey driven approach that extracts user journey data, creates a prioritized feature roadmap, and facilitates effective decision making during the migration process, prioritizing migration of features of components based on hits from users as they interact with those components, ranking migration of those features according to business priorities, merging both the user journey data and business priorities to provide a migration priority that accurately reflects the overall business needs, ensuring that the development team focuses on migrating the most important and impactful features first, providing a more data-driven and strategic approach to feature development, resulting in a better user experience and increased business value, and enabling more efficient use of development resources by ensuring that the team is working on the highest priority features first.

In contrast to conventional technologies, in at least some implementations in accordance with the current technique as described herein, a component development migration system receives, by a reverse proxy server, a Hypertext Transfer Protocol (HTTP) request from a client system, where the reverse proxy server intercepts the HTTP request between the client system and a server. A listener module associated with the reverse proxy server captures a digital footprint of the HTTP request, where the digital footprint identifies a feature associated with an enterprise application. The component development migration system determines a feature score associated with the feature, and determines an overall feature score using a weighted feature score and a weighted feature priority score. The component development migration system migrates development of a component of the enterprise application to a second enterprise application according to the overall feature score, where the feature is associated with the component.

In an example embodiment of the current technique, the reverse proxy server receives a new HTTP request. The component development migration system determines an updated overall feature score based on the new HTTP request, and updates the migrating based on the updated overall feature score.

In an example embodiment of the current technique, the listener module logs an API call associated with a client server session, where the client server session comprises the HTTP request intercepted between the client system and the server.

In an example embodiment of the current technique, the listener module retrieves uniform resource identifier (URI) information and an argument list from the HTTP request received from the client system, stores the URI information and the argument list in a data structure, and stores a session identifier, associated with the HTTP request transmitted from the client system to the server, in a data structure.

In an example embodiment of the current technique, the listener module maintains a counter to track a number of times a uniform resource identifier (URI) is accessed.

In an example embodiment of the current technique, the listener module retrieves a status code associated with an HTTP response, where the HTTP response is received in response to the HTTP request transmitted to the server, and updates a data structure with the status code.

In an example embodiment of the current technique, the data structure comprises URI information, an argument list, a counter, and a session identifier associated with the URI information, from the HTTP request.

In an example embodiment of the current technique, the normalizer module identifies a graph data structure associated with a user session on the client system, where the graph data structure is comprised of at least one node data structure, where at least one node data structure comprises a session identifier associated with the user session, URI information, an argument list from the HTTP request, a counter associated with the URI information, and a status code associated with an HTTP response, and where the HTTP response is received in response to the HTTP request transmitted to the server.

In an example embodiment of the current technique, the normalizer module analyzes a plurality of graph data structures, where each graph data structure in the plurality of graph data structures is comprised of a plurality of node data structures, where each of the plurality of node data structures is associated with a session id associated with the HTTP request, and identifies a subset of the plurality of the graph data structures that are associated with a success status code, where the success status code is associated with an HTTP response received in response to the HTTP request transmitted to the server.

In an example embodiment of the current technique, the normalizer module normalizes the subset of the plurality of the graphs associated with the success status codes, removes duplicates from the normalized subset of the plurality of graphs to identify unique node data structures, and assigns a priority to each unique node data structure, where the priority is associated with a counter respectively associated with each unique node data structure.

In an example embodiment of the current technique, the transmitter module transmits a plurality of unique node data structures to a machine learning system, where the plurality of unique node data structures is transmitted in an order associated with the priority assigned to each unique node data structure, and the machine learning system maps each of the unique node data structures to a respective feature from a feature repository.

In an example embodiment of the current technique, the machine learning system comprises a Natural Language Processing (NLP) model.

In an example embodiment of the current technique, component development migration system determines the feature score for each respective feature, where the feature score is associated with the priority assigned to each unique node data structure.

In an example embodiment of the current technique, the component development migration system retrieves from a feature repository, a feature priority associated with the feature, and weights the feature priority.

In an example embodiment of the current technique, the feature priority is a sum of feature metrics associated with the feature.

In an example embodiment of the current technique, the component development migration system sums the weighted feature score and the weighted feature priority to determine the overall feature score.

In an example embodiment of the current technique, the component development migration system transmits the feature and the associated overall feature score to a project management tool, where the overall feature score provides a migration priority with which the feature is to be migrated to the second enterprise application, where the feature associated with a higher overall feature score is migrated to the second enterprise application ahead of the feature with a lower overall feature score. In an example embodiment, the project management tool outputs the list of features and the order in which development of those features are to be migrated from the enterprise application to the second enterprise application.

In an example embodiment of the current technique, the component development migration system migrates data from a database to a second database, and/or migrates an application from a server to a second server, and/or upgrades an operating system to a second operating system, and/or migrates the application from a platform to a second platform, and/or migrates the application from a programming language to a second programming language.

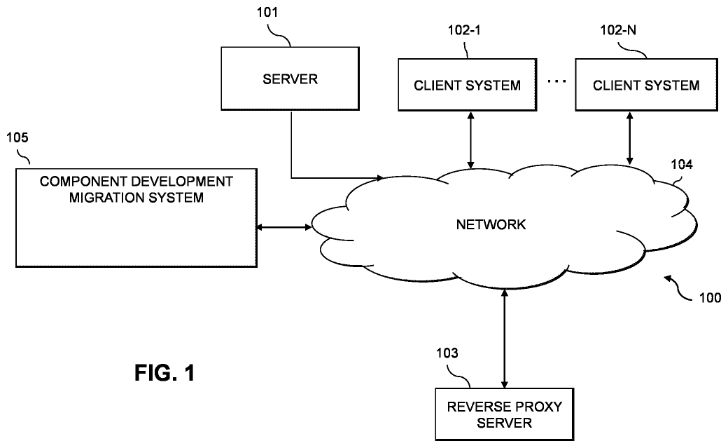

FIG. 1 shows a computer network (also referred to herein as an information processing system) 100 configured in accordance with an illustrative embodiment. The computer network 100 comprises a server 101, component development migration system 105, reverse proxy server 103, and client systems 102-N. The server 101, component development migration system 105, reverse proxy server 103, and client systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. The component development migration system 105 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the client systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The client systems 102-N in some embodiments comprise respective computers associated with a particular company, organization or other enterprise. In addition, at least portions of the computer network 100 may also be referred to herein as collectively comprising an “enterprise network”, where elements of the enterprise network may execute enterprise applications. Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the component development migration system 105 are one or more input-output devices, which illustratively comprise keyboards, displays or other types of input-output devices in any combination. Such input-output devices can be used, for example, to support one or more user interfaces to the component development migration system 105, as well as to support communication between the component development migration system 105 and other related systems and devices not explicitly shown. For example, a dashboard may be provided for a user to view a progression of the execution of the component development migration system 105. One or more input-output devices may also be associated with any of the client systems 102-N.

Additionally, the component development migration system 105 in the FIG. 1 embodiment is assumed to be implemented using at least one processing device. Each such processing device generally comprises at least one processor and an associated memory, and implements one or more functional modules for controlling certain features of the component development migration system 105.

More particularly, the component development migration system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the component development migration system 105 to communicate over the network 104 with the server 101, and client systems 102-N and illustratively comprises one or more conventional transceivers.

A component development migration system 105 may be implemented at least in part in the form of software that is stored in memory and executed by a processor, and may reside in any processing device. The component development migration system 105 may be a standalone plugin that may be included within a processing device.

It is to be understood that the particular set of elements shown in FIG. 1 for component development migration system 105 involving the server 101, and client systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the component development migration system 105 can be on and/or part of the same processing platform.

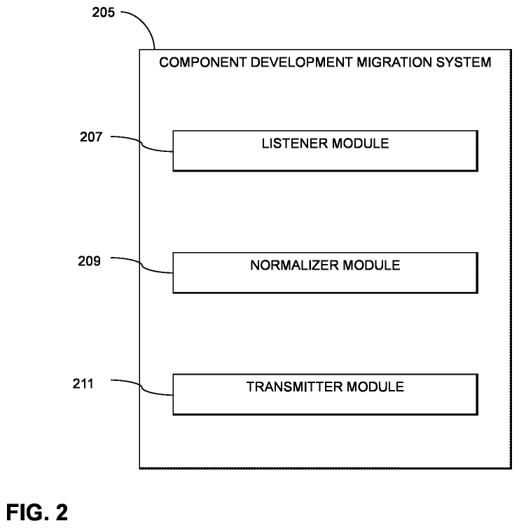

FIG. 2 shows a component development migration system 205 in an illustrative embodiment. In an example embodiment, the component development migration system 205 comprises the listener module 207, normalizer module 209, and transmitter module 211. In an example embodiment, the listener module 207 actively logs the API calls of every client server session with the help of the reverse proxy server 103. In an example embodiment, the listener module 207 retrieves the URI information and argument list from the HTTP request sent by the client system 102-N to the server 101, and then stores the information in a data structure. In an example embodiment, the listener module 207 stores a session identifier, associated with the HTTP request in the data structure. In an example embodiment, the listener module 207 maintains a counter to track the number of times a URI is accessed. This value is also referred to as “user hits”. This step may also be referred to as the data collection step where user stories (i.e., the user stories are also known as the user journeys, where the digital footprints capture the user stories/user journeys) with classified headers are collected. In this example embodiment, the classified headers are the respective URIs. The step of collecting the user journey data comprises collecting data on how the users are interacting with the application, including which features are used the most, which features are causing the most friction, and which features are receiving the most feedback or complaints. In an example embodiment, the user journey data is collected through user surveys, feedback forms, analytics tools, user testing, etc.

In an example embodiment, the listener module 207 retrieves a status code from the HTTP response and updates the data structure with the status code. In an example embodiment, the listener module 207 evaluates error status codes for server and/or application errors, and reports them out to, for example, the development team. In doing so, the component development migration system 205 accelerates the defect detection and resolution process.

In an example embodiment, the normalizer module 209 identifies data that have success status codes in the data structure (i.e., the node data structure). In an example embodiment, the normalizer module 209 normalizes the data structure to identify any unique node data structures (i.e., unique sets of actions performed across a plurality of client sessions). In an example embodiment, the normalizer module 209 removes duplicate user actions/node data structures to identify the unique sets of actions performed across the plurality of client sessions.

In an example embodiment, the transmitter module 211 transmits the normalized test data (i.e., the unique sets of actions performed across the plurality of client sessions) to a machine learning system.

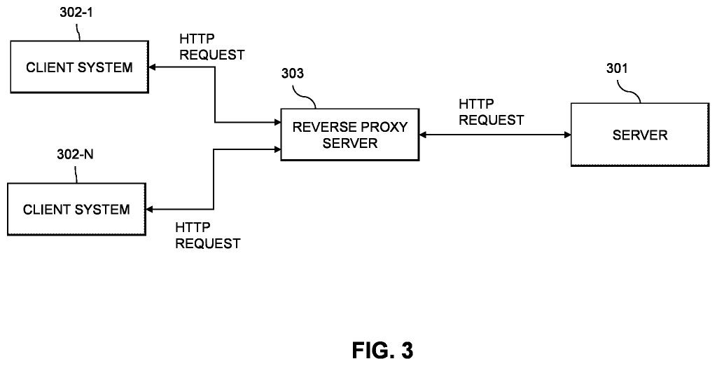

FIG. 3 shows a reverse proxy server interfacing with client systems and a server in an illustrative embodiment. In an example embodiment, the reverse proxy server 103 intercepts the HTTP request as the HTTP request is transmitted from the client system 302-N to the server 301.

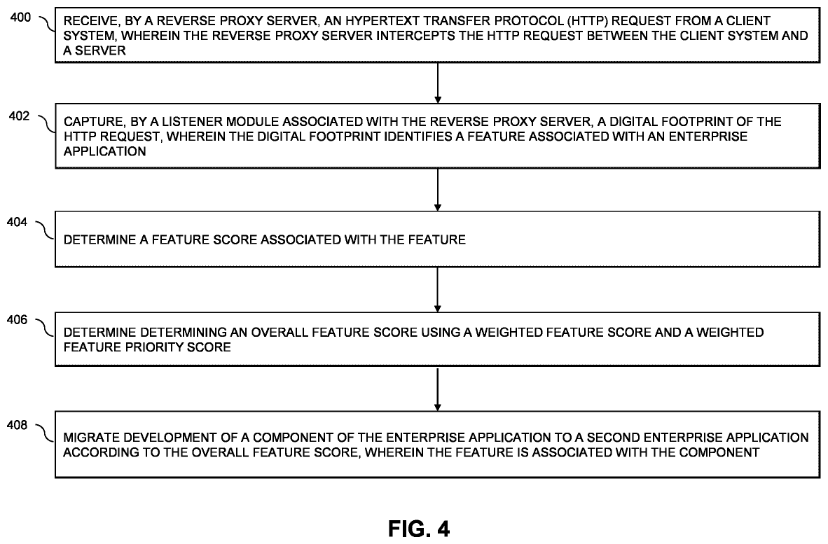

An exemplary process of component development migration system 105 in computer network 100 will be described in more detail with reference to, for example, the flow diagram of FIG. 4. The component development migration system 105 tracks the actions of end users.

FIG. 4 is a flow diagram of a process for execution of the component development migration system 105 in an illustrative embodiment. It is to be understood that this particular process is only an example, and additional or alternative processes can be carried out in other embodiments.

At 400, the reverse proxy server 103 receives a HTTP request from a client system, where the reverse proxy server 103 intercepts the HTTP request between the client system and a server as depicted in FIG. 3.

At 402, the listener module 207, associated with the reverse proxy server 103, captures a digital footprint of the HTTP request, where the digital footprint identifies a feature associated with an enterprise application. In an example embodiment, the listener module 207 logs an API call associated with a client server session, where the client server session comprises the HTTP request intercepted between the client system and the server. In an example embodiment, the listener module 207 retrieves uniform resource identifier (URI) information and an argument list from the HTTP request received from the client system and stores the URI information and the argument list in a data structure. In an example embodiment, the listener module 207 executes $get_url( ), $get_args( ) commands to fetch the information along with session information. In an example embodiment, the listener module 207 stores a session identifier, associated with the HTTP request transmitted from the client system to the server, in the data structure. In an example embodiment, the listener module 207 maintains a counter to track a number of times a uniform resource identifier (URI) is accessed.

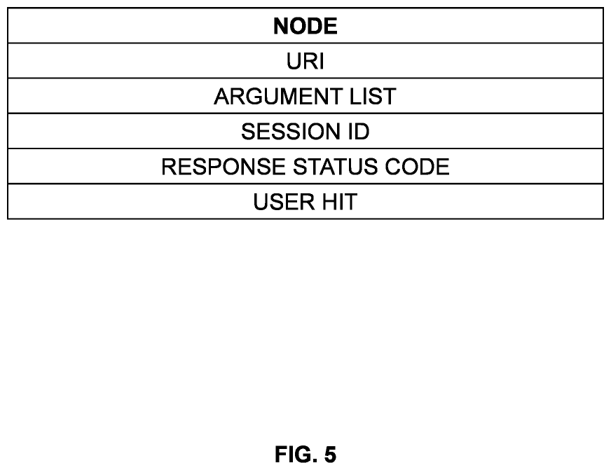

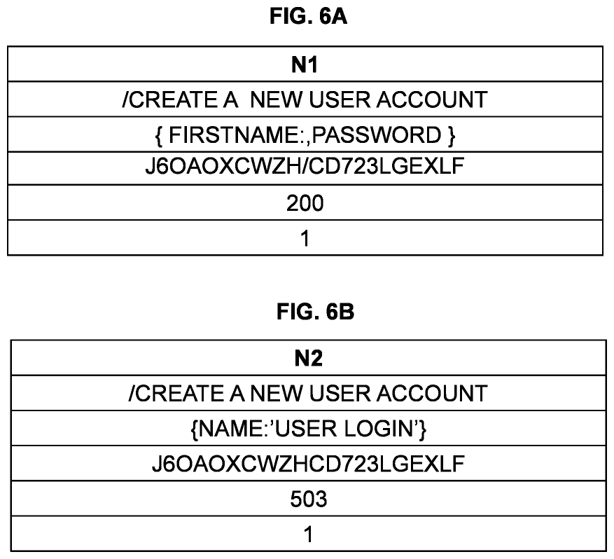

In an example embodiment, the listener module 207 stores the URI information, argument list, counter, and session identifier in a data structure, such as a node data structure as illustrated in FIG. 5 and FIGS. 6A and 6B. In an example embodiment, the listener module 207 captures each user session in a plurality of node data structures, where each node data structure contains URI information, argument list, counter, and session identifier. The listener module 207 captures this information within the node data structures until the user session ends.

In an example embodiment, the listener module 207 retrieves a status code associated with an HTTP response, where the HTTP response is received in response to the HTTP request transmitted to the server, and updates a node data structure with the status code as illustrated in FIG. 5 and FIGS. 6A and 6B, where FIG. 6A illustrates a “Success” node, and FIG. 6B illustrates a “Service Unavailable Response” node. In other words, the listener module 207 fetches the status code and message associated with the HTTP response, and updates the corresponding node data structure with the response status code as illustrated in FIG. 5, and FIGS. 6A and 6B.

In an example embodiment, if the component development migration system 105 identifies a status code indicating an unsuccessful HTTP response, the component development migration system 105 immediately reports out a defect, based on an evaluation of the status error of the HTTP response. The defect may be reported out to, for example, a development team that would be tasked with analyzing and resolving the defect. This facilitates early detection of errors, for example, on the server side, and accelerates detection, resolution, and deployment of fixes for the detected errors.

In an example embodiment, the listener module 207 stores the plurality of nodes associated with a user session in a graph data structure. In an example embodiment, each user session is captured into a graph data structure that comprises a plurality of node data structures. In an example embodiment, the graph data structures represent complex interactions between different elements of the web application, such as pages, buttons, and forms, revealing how users interact with the web application. The graph data structures also identify patterns of end user behavior, and captures the paths that users take as they access the web application. The graph data structures reveal relationships and patterns between the different elements of the web application, such as pages and buttons. In an example embodiment, the graph data structures may identify the areas of the web application that are underutilized.

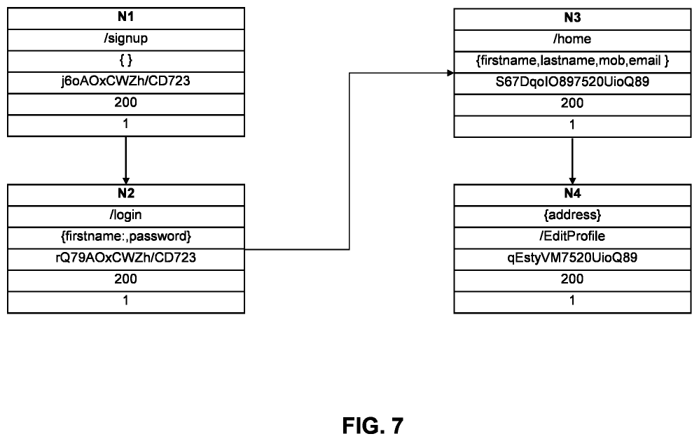

In an example embodiment, the listener module 207 identifies a graph data structure associated with a user session on the client system, where the graph data structure is comprised of at least one node data structure, and that node data structure comprises a session identifier associated with the user session, URI information, an argument list from the HTTP request, a counter associated with the URI information, and a status code associated with an HTTP response, where the HTTP response is received in response to the HTTP request transmitted to the server. FIG. 7 illustrates an example graph data structure comprised of a plurality of node data structures.

In an example embodiment, the normalizer module 209 analyzes a plurality of graph data structures, where each graph data structure in the plurality of graph data structures is comprised of a plurality of node data structures where each of the plurality of node data structures is associated with a session id associated with the HTTP request, as illustrated in FIG. 7. In an example embodiment, the normalizer module 209 identifies a subset of the plurality of the graph data structures that are associated with a success status code. The success status code is associated with an HTTP response received in response to the HTTP request transmitted to the server. In an example embodiment, each of the plurality of node data structures associated with a graph data structure is associated with a session id associated with the HTTP request.

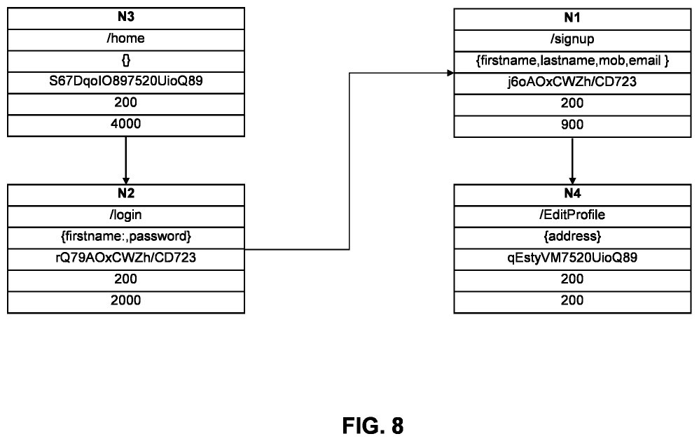

In an example embodiment, the normalizer module 209 normalizes the subset of the plurality of the graphs associated with the success status codes, and removes duplicates from the normalized subset of the plurality of graphs to identify unique node data structures as illustrated in FIG. 8. In an example embodiment, the priority is associated with a counter respectively associated with each unique node data structure. The above-described steps are referred to as the data cleaning and preprocessing step, comprising data formatting and deduplication.

In an example embodiment, the normalizer module 209 assigns a priority to each unique node data structure based on the number of user hits (which is tracked by the counter in the node data structure). FIG. 8 illustrates how the plurality of node data structures of FIG. 7 have been ranked according to their respective priority.

At 404, the component development migration system 105 determines a feature score associated with the feature. In an example embodiment, the transmitter module 211 transmits a plurality of unique node data structures to a machine learning system. In an example embodiment, the plurality of unique node data structures is transmitted in an order associated with the priority assigned to each unique node data structure. In an example embodiment, the machine learning system comprises a Natural Language Processing (NLP) model to map user journeys (captured in the node data structures and the graph data structures) to features associated with the enterprise application. An example of pre-defined features is listed below:

Functionality

Login
Search Product
Add to Cart
Move to Wishlist
Billing
Customer Support - Chat
Customer Support - Call
Forgot Password
Add User Details
Create User Account

In an example embodiment, the component development migration system 105 extracts the feature information from the unique node data structures using the NLP technique “Term Frequency-Inverse Document Frequency” (TF-IDF). In an example embodiment, the machine learning system maps each of the unique node data structures to a respective feature from a feature repository. The above steps are referred to as the feature extraction step. The next step is referred to as the labeling step where the component development migration system 105 assigns labels to the user stories based on the header criteria. An example table below illustrates how features are mapped to feature metrics, and the associated values. In an example embodiment, a score is assigned for each feature (or user story) based on its business priority and user journey data. In an example embodiment, decision making metrics are predefined for the user interface applications. In an example embodiment, a weight is assigned to each metric by product subject matter expert(s). In an example embodiment, the weight values assigned to each metric are used to evaluate the overall impact of that metric on the application. In the example table illustrated below, a scale of 1 to 10 is used, where 10 is the highest priority.

| | | Feature | | | Compet- | |
|---|---|---|---|---|---|---|
| | Business | Depen- | | Rev- | itive | Targeted |
| Features | Value | dencies | Cost | enue | Analysis | Business |
| Login | 10 | 10 | 9 | 7 | 8 | 7 |
| Search | 7 | 8 | 6 | 6 | 5 | 5 |
| Product | | | | | | |
| Add to Cart | 10 | 8 | 10 | 10 | 8 | 5 |
| Move to | 7 | 7 | 7 | 7 | 6 | 5 |
| Wishlist | | | | | | |
| Billing | 10 | 9 | 9 | 10 | 8 | 7 |
| Customer | 8 | 6 | 7 | 7 | 5 | 5 |
| Support - | | | | | | |
| Chat | | | | | | |
| Customer | 7 | 6 | 6 | 6 | 5 | 5 |
| Support - | | | | | | |
| Call | | | | | | |
| Forgot | 6 | 6 | 7 | 6 | 6 | 6 |
| Password | | | | | | |
| Add User | 10 | 7 | 8 | 6 | 5 | 6 |
| Details | | | | | | |
| Create User | 10 | 9 | 8 | 7 | 6 | 5 |
| Account | | | | | | |

In an example embodiment, business priorities are gathered. In an example embodiment, machine learning algorithms are leveraged to analyze data on the business priorities. In this example embodiment, the data may be gathered from business stakeholders, other data sources, etc. For example, stakeholders may provide business priorities associated with each functionality or user story. Stakeholders may include product owners or business analysts. The business priorities may include factors such as revenue impact, customer impact, strategic importance, and/or regulatory compliance requirements.

In an example embodiment, the component development migration system 105 determines the feature score for each respective feature, where the feature score is associated with the priority assigned to each unique node data structure. In an example embodiment, the feature score is determined based on the number of user hits (which is tracked in the counter value in the node data structure).

At 406, the component development migration system 105 determines the overall feature score. In an example embodiment, the component development migration system 105 retrieves, from a feature repository, a feature priority associated with the feature, and weights the feature priority. In an example embodiment, the feature priority is the sum of feature metrics associated with the feature. For example, using the above table, the feature priority score for the “Login” feature is the sum of all the feature metrics associated with the “Login” features, i.e., 10+10+9+7+8+7=51.

In an example embodiment, the component development migration system 105 assigns weights to each feature score and to each feature priority. In an example embodiment, a weight of 70% is assigned to the feature priority and a weight of 30% is assigned to the feature score.

In an example embodiment, the component development migration system 105 determines the overall feature score by summing the weighted feature score and the weighted feature priority. For example, for feature “A”, the feature priority is assigned a weight of 60% and the feature score is assigned a weight of 40%.
Feature priority score: 80
Feature score: 60
Weighted feature priority score: 80*0.6=48
Weighted feature score: 60*0.4=24
Overall feature score: 48+24=72

In another example embodiment, for feature “B”, the feature priority is assigned a weight of 60% and the feature score is assigned a weight of 40%.
Feature priority score: 70
Feature score: 80
Weighted feature priority score: 70*0.6=42
Weighted feature score: 80*0.4=32
Overall score: 42+32=74

At 408 the component development migration system 105 migrates development of a component of the enterprise application to a second enterprise application according to the overall feature score, where the feature is associated with the component. In an example embodiment, the component development migration system 105 prioritizes any backlog associated with migrating the component of the enterprise application to the second enterprise application by sorting the user journeys based on their respective overall feature scores. The user stories with the highest scores are prioritized first. The features that are mapped to those user stores have priority to be migrated to the second enterprise application.

In an example embodiment, the component development migration system 105 transmits the feature and the associated overall feature score to a project management tool, where the overall feature score provides a migration priority with which the feature is to be migrated to the second enterprise application. The feature associated with a higher overall feature score is migrated to the second enterprise application ahead of the feature with a lower overall feature score. In other words, the component development migration system 105 sends the feature information and overall feature score to the project management tool to queue up the order in which development of the feature should be migrated from the enterprise application to the second enterprise application.

Migrating an application to a new platform is a challenging task that requires a comprehensive understanding of the user journey, digital footprint and subject matter expertise. There may be several migrations in this scope. In an example embodiment, the component development migration system 105 migrates data from a database to a second database according to the overall feature score. For example, the component development migration system 105 provides an overall feature score for components associated with upgrading an older version of a database to a newer version of the database, or moving data to a cloud-based database.

In an example embodiment, the component development migration system 105 migrates an application from a server to a second server. For example, the component development migration system 105 provides an overall feature score for components associated with moving application(s) from a physical server to a virtual server, or a cloud-based server.

In an example embodiment, the component development migration system 105 provides an overall feature score for components associated with upgrading and/or changing an operating system on which the application is running to a second operation system. For example, a Windows-based operating system is changed to a Linux-based operating system.

In an example embodiment, the component development migration system 105 migrates the application from a platform to a second platform. For example, the component development migration system 105 provides an overall feature score for components associated with moving application(s) from a desktop platform to a web-based platform. In another example embodiment, the component development migration system 105 provides an overall feature score for components associated with moving application(s) from a monolithic architecture to a microservices architecture.

In an example embodiment, the component development migration system 105 migrates the application from a programming language to a second programming language. For example, the component development migration system 105 provides an overall feature score for components associated with moving application(s) from Java to Python, or from Hypertext Preprocessor (PHP) to Node.js.

In an example embodiment, the reverse proxy server receives a new HTTP request. In response, the component development migration system 105 determines an updated overall feature score based on the new HTTP request, and updates the migration step based on the updated overall feature score. In other words, the order in which the components of the enterprise application are migrated to a second enterprise application may change based on the updated feature score. Thus, the component development migration system 105 refines and iterates the prioritization process as feedback is received from stakeholders, changes in business priorities, user needs, and/or as the data associated with the user journeys change. The component development migration system 105 continuously improves and adapts to changing business priorities and user requirements.

In an example embodiment, the component development migration system 105 trains the machine learning system. The preprocessed data (i.e., the unique node data structures), are split into a training set and a testing set. For example, 20% of the unique node data structures are used to train the machine learning system and 80% of the unique node data structures are used to test the machine learning system, and evaluate the machine learning system's performance. This step is referred to as the training and testing step.

In an example embodiment, the model selection step determines the model used in the machine learning system. For example, the Naïve Bayes model is selected for classification. The model training step then trains the Multinomial Naïve Bayes classifier model using the preprocessed training set data (for example, the 20% of the unique node data structures). The model evaluation step evaluates the performance of the trained machine learning system model on the testing set (for example, 80% of the unique node data structures).

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to generate a more efficient and data driven road map for enterprise application migration. These and other embodiments can effectively ensure that the development team focuses on the most important and impactful features first relative to conventional approaches. Embodiments disclosed herein focus on the user journeys as the driver in the migration process, prioritizing critical functionalities based on the user needs and behavior. Embodiments disclosed herein combine the feature priorities and the user journey data to create a measure of complexity that reflects both the business value and user experience of a migrated feature. Embodiments disclosed herein generate a more efficient, data driven roadmap by using digital footprints provided by user journeys. Embodiments disclosed herein use a user journey driven approach that extracts user journey data, creates a prioritized feature roadmap, and facilitates effective decision making during the migration process. Embodiments disclosed herein prioritize migration of features of components based on hits from users as they interact with those components. Embodiments disclosed herein rank migration of those features according to business priorities. Embodiments disclosed herein merge both the user journey data and business priorities to provide a migration priority that accurately reflects the overall business needs. Embodiments disclosed herein ensure that the development team focuses on migrating the most important and impactful features first. Embodiments disclosed herein provide a more data-driven and strategic approach to feature development, resulting in a better user experience and increased business value. Embodiments disclosed herein enable more efficient use of development resources by ensuring that the team is working on the highest priority features first.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

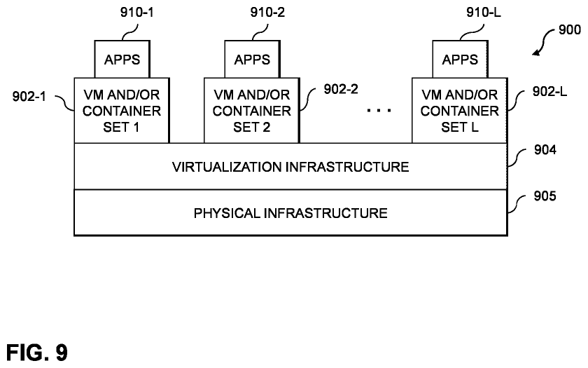

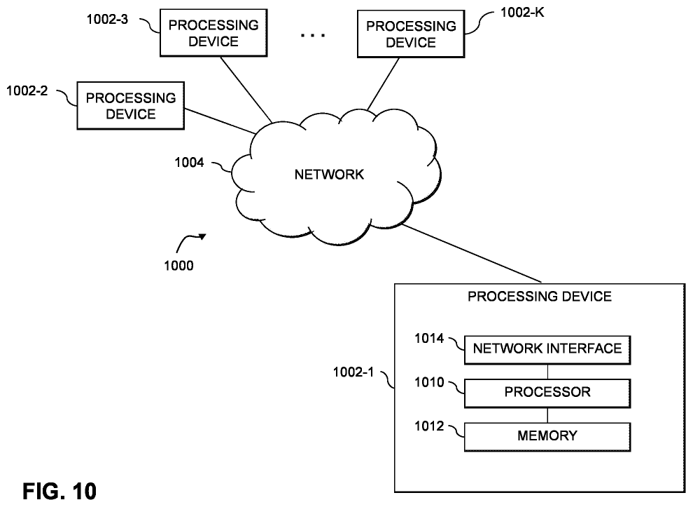

Illustrative embodiments of processing platforms will now be described in greater detail with reference to FIGS. 9 and 10. Although described in the context of the information processing system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, where the hypervisor platform has an associated virtual infrastructure management system. The underlying physical machines comprise one or more distributed processing platforms that include one or more storage systems.

In other implementations of the FIG. 9 embodiment, the VMs/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of the information processing system 100 and includes a plurality of processing devices, denoted 1002-1, 1002-2, 1002-3, . . . 1002-K, which communicate with one another over a network 1004.

The network 1004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1002-1 in the processing platform 1000 comprises a processor 1010 coupled to a memory 1012.

The processor 1010 comprises a microprocessor, a microcontroller, an application-specific integrated circuit (ASIC), a field-programmable gate array (FPGA) or other type of processing circuitry, as well as portions or combinations of such circuitry elements.

The memory 1012 comprises random access memory (RAM), read-only memory (ROM) or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 804 and other system components, and may comprise conventional transceivers.

The other processing devices 1002 of the processing platform 1000 are assumed to be configured in a manner similar to that shown for processing device 1002-1 in the figure.

Again, the particular processing platform 1000 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving, by a reverse proxy server, a Hypertext Transfer Protocol (HTTP) request from a client system, wherein the reverse proxy server intercepts the HTTP request between the client system and a server;
capturing, by a listener module associated with the reverse proxy server, a digital footprint of the HTTP request, wherein the digital footprint identifies a feature associated with an enterprise application;
determining a feature score associated with the feature;
determining an overall feature score using a weighted feature score and a weighted feature priority score; and
migrating development of a component of the enterprise application to a second enterprise application according to the overall feature score, wherein the feature is associated with the component, and wherein the method is performed by at least one processing device comprising a processor coupled to a memory.

2. The method of claim 1 further comprising:
receiving, by the reverse proxy server, a new HTTP request;
determining an updated overall feature score based on the new HTTP request; and
updating the migrating based on the updated overall feature score.

3. The method of claim 1 wherein capturing, by the listener module, comprises:
logging, by the listener module, an API call associated with a client server session, wherein the client server session comprises the HTTP request intercepted between the client system and the server.

4. The method of claim 1 wherein capturing, by the listener module, comprises:
retrieving uniform resource identifier (URI) information and an argument list from the HTTP request received from the client system;
storing the URI information and the argument list in a data structure; and
storing a session identifier, associated with the HTTP request transmitted from the client system to the server, in a data structure.

5. The method of claim 1 wherein capturing, by the listener module, comprises:
maintaining a counter to track a number of times a uniform resource identifier (URI) is accessed.

6. The method of claim 1 wherein capturing, by the listener module, comprises:
retrieving a status code associated with an HTTP response, wherein the HTTP response is received in response to the HTTP request transmitted to the server; and
updating a data structure with the status code.

7. The method of claim 6 wherein the data structure comprises URI information, an argument list, a counter, and a session identifier associated with the URI information, from the HTTP request.

8. The method of claim 1 wherein capturing, by the listener module, comprises:
identifying a graph data structure associated with a user session on the client system, wherein the graph data structure is comprised of at least one node data structure, wherein the at least one node data structure comprises a session identifier associated with the user session, URI information, an argument list from the HTTP request, a counter associated with the URI information, and a status code associated with an HTTP response, wherein the HTTP response is received in response to the HTTP request transmitted to the server.

9. The method of claim 1 wherein capturing, by the listener module, comprises:
analyzing, by a normalizer module, a plurality of graph data structures, wherein each graph data structure in the plurality of graph data structures is comprised of a plurality of node data structures wherein each of the plurality of node data structures is associated with a session id associated with the HTTP request; and
identifying a subset of the plurality of the graph data structures that are associated with a success status code, wherein the success status code is associated with an HTTP response received in response to the HTTP request transmitted to the server.

10. The method of claim 9 further comprising:
normalizing, by the normalizer module, the subset of the plurality of the graphs associated with the success status codes;
removing duplicates from the normalized subset of the plurality of graphs to identify unique node data structures; and
assigning a priority to each unique node data structure, wherein the priority is associated with a counter respectively associated with each unique node data structure.

11. The method of claim 1 wherein determining a feature score associated with the feature comprises:
transmitting, by a transmitter module, a plurality of unique node data structures to a machine learning system, wherein the plurality of unique node data structures is transmitted in an order associated with the priority assigned to each unique node data structure; and
mapping, by the machine learning system, each of the unique node data structures to a respective feature from a feature repository.

12. The method of claim 11 wherein the machine learning system comprises a Natural Language Processing (NLP) model.

13. The method of claim 11 further comprising:
determining the feature score for each respective feature, wherein the feature score is associated with the priority assigned to each unique node data structure.

14. The method of claim 1 wherein determining the overall feature score comprises:
retrieving from a feature repository, a feature priority associated with the feature; and
weighting the feature priority.

15. The method of claim 14 wherein the feature priority is a sum of feature metrics associated with the feature.

16. The method of claim 1 wherein determining the overall feature score comprises:
summing the weighted feature score and the weighted feature priority to determine the overall feature score.

17. The method of claim 1 wherein migrating development of the component of the enterprise application to the second enterprise application comprises:
transmitting the feature and the associated overall feature score to a project management tool, wherein the overall feature score provides a migration priority with which the feature is to be migrated to the second enterprise application, wherein the feature associated with a higher overall feature score is migrated to the second enterprise application ahead of the feature with a lower overall feature score.

18. The method of claim 1 wherein migrating development of the component of the enterprise application to the second enterprise application comprises:
migrating data from a database to a second database;
migrating an application from a server to a second server;
upgrading an operating system to a second operating system;
migrating the application from a platform to a second platform; and
migrating the application from a programming language to a second programming language.

19. A system comprising:
at least one processing device comprising a processor coupled to a memory;
the at least one processing device being configured:
to receive, by a reverse proxy server, a Hypertext Transfer Protocol (HTTP) request from a client system, wherein the reverse proxy server intercepts the HTTP request between the client system and a server;
to capture, by a listener module associated with the reverse proxy server, a digital footprint of the HTTP request, wherein the digital footprint identifies a feature associated with an enterprise application;
to determine a feature score associated with the feature;
to determine an overall feature score using a weighted feature score and a weighted feature priority score; and
to migrate development of a component of the enterprise application to a second enterprise application according to the overall feature score.

20. A computer program product comprising a non-transitory processor-readable storage medium having stored therein program code of one or more software programs, wherein the program code when executed by at least one processing device causes said at least one processing device:
to receive, by a reverse proxy server, a Hypertext Transfer Protocol (HTTP) request from a client system, wherein the reverse proxy server intercepts the HTTP request between the client system and a server;
to capture, by a listener module associated with the reverse proxy server, a digital footprint of the HTTP request, wherein the digital footprint identifies a feature associated with an enterprise application;
to determine a feature score associated with the feature;
to determine an overall feature score using a weighted feature score and a weighted feature priority score; and
to migrate development of a component of the enterprise application to a second enterprise application according to the overall feature score.
